(19) United States
(12) Patent Application Publication
(10) Pub. No.: US 2014/0232312 A1
(43) Pub. Date: Aug. 21, 2014

(54) METHOD FOR STARTING A WASHING MACHINE ELECTRIC MOTOR

(71) Applicant: Whirlpool S.A., Sao Paulo - SP (BR)

(72) Inventor: Omar R Murad, Rio Claro (BR)

(73) Assignee: Whirlpool S.A., Sao Paulo - SP (BR)

(21) Appl. No.: 14/182,721

(22) Filed: Feb. 18, 2014

(30) Foreign Application Priority Data
Feb. 19, 2013 (BR) 10 2013 003829 6

(51) Int. Cl. H02P 1/16

(52) U.S. Cl. CPC H02P 1/16
USPC 318/430

(57) ABSTRACT

The present invention relates to a method for starting a washing machine electric motor and, more particularly, an adaptive method for starting a washing machine electric motor, which is especially able to control the firing angle (preferably during the centrifugation cycles) of the voltage cycles depending on the electrical supply voltage and its possible and unpredictable variations and/or oscillations. Such firing angle control of the electrical supply voltage of the electric motor comprises a dynamic control based on the result of the comparisons in the previous steps, and is performed by generating at least one additional correction signal (ASC) based on the result of the comparison between the actual value of the electrical supply voltage of the electric motor and at least one predetermined reference value, and the additional correction signal (ASC) being responsible for controlling the firing angle of the electrical supply voltage of the electric motor.

### FIELD OF THE INVENTION

The present invention relates to a method for starting a washing machine electric motor and, more particularly, an adaptive method for starting a washing machine electric motor, which is especially able to control the firing angle (preferably during centrifugation cycles) of the voltage cycles depending on the electrical supply voltage and its possible and unpredictable variations and/or oscillations.

### BACKGROUND OF THE INVENTION

As commonly known by a person skilled in the art, washing machines comprise machines mainly based on rotating operations. For this purpose, washing machines, in general, comprise at least one electric motor (and other functional components).

The electric motor of a washing machine is usually linked to a control system able to switch the standard operation of said electric motor depending on different washing cycles performed by the washing machine.

Thus, in the washing step, the electric motor is controlled so as to have its cyclical and consecutively changed rotation.

During the centrifugation step, the electric motor remains in operation at constant speed for a determined time, which is related to the residual moisture of textiles during the washing process. In these circumstances, the temperature of the electric motor package tends to increase exponentially, with an upward thermal behavior, where the final temperature is a function of several factors, such as time, voltage, load, temperature stability of the system, among others.

Notably, the increase in temperature of the electric motor during the centrifugation cycles, it is a negative and mostly undesirable feature from an economic point of view.

This is because, in order to support the temperature increasing cited above, the electric motor needs to be made from overestimated calculations, which aims to (by estimating the thickness of the motor electrical conductors, the estimation of thermal protectors, among others) avoid problems in general at times when the electric motor package reaches high temperatures (relative to the rated operating temperatures).

On the other hand, as should be well known by a person skilled in the art, it also occurs that, due to the Joule effect, the overheating results in further higher energy consumption is disadvantageous from the standpoint of consumers in general.

In order to tackle these problems, it appears that the current state of the art comprises methodologies for starting a washing machine electric motor, which is provided for power control based on the reduction of the effective voltage (RMS voltage) supplied to said electric motor.

The document PI 0402937-2 describes a method for reducing energy consumption in a washing machine through the power control implemented by thyristors able to change the “firing” of the electrical supply voltage of the electric motor. In this technique, the sine wave of the network is “cut” through the use of TRIACs or SCRs and a firing control microprocessor circuit. By reducing the effective voltage in the motor, during the centrifugation step, the magnetizing current of the motor is reduced, decreasing the magnetic losses and joule, and it is possible to achieve benefits with regard to temperature increasing and energy consumption.

Even though the method described in document PI 0402937-2 reaches most of the aims that it is supposed to achieve, it appears that, because of the electric power voltage variations, the application of power control by the firing of TRIAC becomes sensitive and requires a dynamic adjustment according to the electrical supply voltage. This is because the use of a fixed firing angle can generate problems of power loss under electrical supply voltage variation conditions, after all, the voltage variations of an electrical grid with a fixed firing, may not be enough to keep the motor in steady state and may even promote motor deceleration.

The present invention arises based on this context.

### OBJECTIVES OF THE INVENTION

Thus, it is an objective of the invention to provide a method for starting a washing machine electric motor able to dynamically and adaptively change, the firing angle of the electrical supply voltage of the electric motor based on the possible and unpredictable variations and/or oscillations of the electrical supply voltage itself.

In this sense, it is also one of the objectives of the present invention that the method for starting a washing machine electric motor is to steadily keep the electromagnetic torque or starting torque.

It is another objective of the present invention that, even upon any kind of electric power voltage variations, the method for starting a washing machine electric motor is able to make the adjustment of the firing angle as a function of rotation and also torque feedback, in order to maintain the constant rotation in dynamic load conditions.

It is still one of the objectives of the present invention to provide a method for starting a washing machine electric motor able to dynamically and adaptively change the firing angle of the electrical supply voltage of the electric motor based on the rotation and torque feedback (characteristics also influenced by possible and unpredictable variations and/or oscillations of electrical supply voltage itself).

### SUMMARY OF THE INVENTION

All the above mentioned objectives are fully achieved by the method for starting a washing machine electric motor herein disclosed, comprising at least the following steps: conventional starting of the electric motor until its steady state; monitoring the electrical supply voltage of the electric motor; comparing the actual value of the electrical supply voltage of the electric motor, monitored in step (b), with at least one predetermined reference value, and maintaining the starting of the electric motor, after the consolidation of its steady state, by controlling the firing angle of the electrical supply voltage of the electric motor.

According to the present invention, the said method for starting a washing machine electric motor differs from the method described in the document PI 0402937-2 by the fact that the firing angle control of the electrical supply voltage of the electric motor comprises a dynamic control based on the results of comparisons made in the previous step. So it is worth noting that the predetermined reference value comprises the rated voltage of the electric motor.

This occurs through the generation of least one additional correction signal based on the result of the comparison between the actual value of the electrical supply voltage of the electric motor and at least one predetermined reference value, and at least one additional correction signal being responsible by controlling the firing angle of the electrical supply voltage of the electric motor. Preferably, at least one additional correction signal is sent, via hardware, to the thyristor responsible for the power supply of the washing machine motor.

Optionally, the present invention also presents a variation of the method for starting a washing machine electric motor, which comprises the steps of conventional activation of the electric motor until its steady state; monitoring at least one magnitude intrinsic to the electric motor operation; comparing the actual value of the magnitude intrinsic to the electric motor operation, monitored in step (b), with at least one predetermined reference value, and maintaining the starting of the electric motor, after the consolidation of its steady state, by controlling the firing angle of the electrical supply voltage of the electric motor; it also provides for said firing angle control of the electrical supply voltage of the electric motor, which comprises a dynamic control based on the result of the comparisons performed in the previous step, where the magnitude intrinsic to the electric motor operation comprises the electric motor torque (wherein the predetermined reference value comprises the electric motor torque), or even, the electric motor speed (wherein the predetermined reference value comprises the electric motor speed).

### BRIEF DESCRIPTION OF THE DRAWINGS

The present invention will be described in detail based on the figures listed below, including:

FIG. 1 illustrates a graph relating to the method proposed in the document PI 0402937-2;

FIG. 2 illustrates a graph relating to the proposed method of document PI 0402937-2, with the occurrence of variations and/or oscillations in electrical supply voltage;

FIG. 3 shows a graph relating to the method for starting a washing machine electric motor according to the present invention;

FIG. 4 illustrates an option of a hardware able to perform the method for starting a washing machine electric motor according to the present invention, and

FIG. 5 illustrates a preferred embodiment of the electronics circuit able to perform the method for starting a washing machine electric motor according to the present invention.

### DETAILED DESCRIPTION OF THE INVENTION

As described previously, the document PI 0402937-2 describes a method to reduce the energy consumption of a washing machine by controlling the firing angle of the electrical supply voltage to be supplied to said washing machine electric motor. In addition to reducing energy consumption, the method described in document PI 0402937-2 also prevents the electric motor package, during the continuous operation cycles (centrifugation cycle) reaches high temperatures.

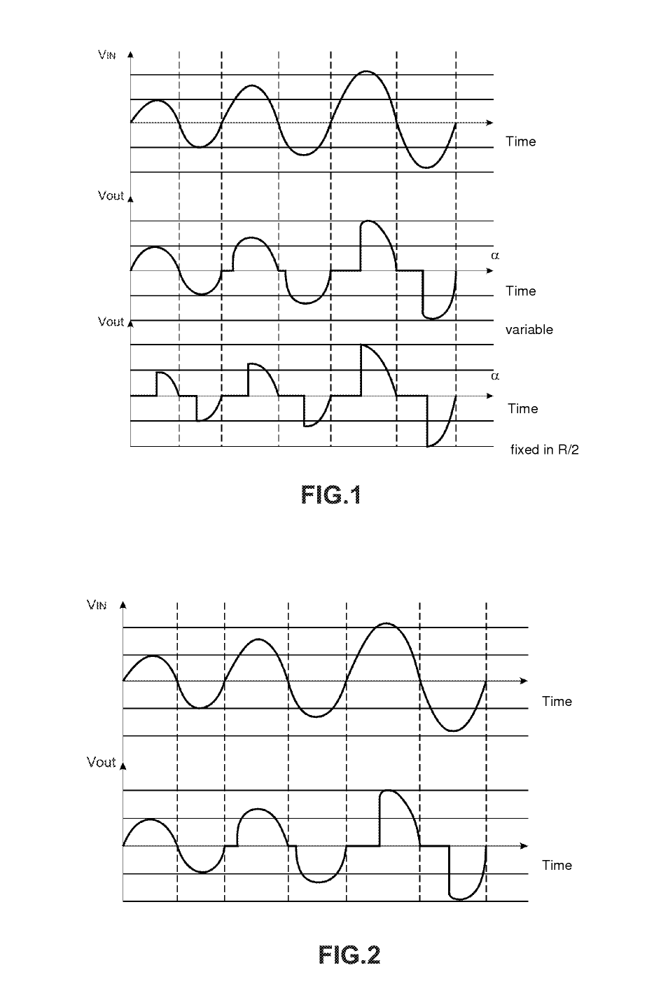

It occurs the said method described in PI document 0402937-2 does not provide for any adjustment to possible and unpredictable variations and/or oscillations of electrical supply voltage. In FIG. 1, it can be seen, for example, according to the document PI 0402937—regardless of the amplitude of the voltage of the electrical grid—the firing angle is fixed and set to 90°.

Consequently, fixed firings by the thyristors may be insufficient to keep the motor in steady state, after all, it is known by a person skilled in the art that fixed firings on electrical grid of variable values tend to generate a turbulent RMS voltage (effective voltage) that, in critical cases, can even generate the electric motor deceleration. The electric motor supply, according to the document PI 0402937, and by the possible and unpredicted changes and/or oscillations of the electrical supply voltage, can be seen in FIG. 2.

Within this context the present invention highlights, after all, it is disclosed herein a method for starting a washing machine electric motor, which complements and optimizes the lessons already described in said document PI 0402937-2.

In this sense, it is disclosed a method for starting a washing machine electric motor where the power supply of the electric motor, which is mostly based on the firing angle control of the electric power voltage is dynamically controlled depending on the variations and oscillations of the electrical grid itself.

Besides, and considering that variations and oscillations of the electrical grid tend to generate oscillations in mechanical magnitudes of the electric motor (speed and torque, for example), it also presents a method for starting a washing machine electric motor where the power supply of the electric motor, which is mostly based on firing angle control of the electric power voltage is dynamically controlled depending on variations and oscillations of the mechanical magnitudes of the electric motor, which are reflections of the variations and oscillations of the electrical grid itself.

It means that the thyristors (or similar solid state relays) will change the electrical supply voltage of the washing machine motor based on the oscillations of the electrical grid or based on mechanical oscillations that, in a greater or lesser degree, are oscillations products of the electrical grid.

Both the oscillations of the electrical grid and the mechanical oscillations can be monitored and measured in accordance with tools, instruments and/or solutions already known by those skilled in the art.

Thus, the oscillations of the electrical grid can be monitored and measured, for example, by voltmeters associated with the existing comparator circuit.

The mechanical oscillations or oscillations of magnitude inherent to the electric motor operation can be measured and monitored, for example by tachometers.

Nevertheless, it is the main objective of the invention to maintain a constant RMS voltage of the electric motor, regardless of the above oscillations through variable and adaptive control of the firing angle of the thyristors or solid state relays.

For this purpose, the said method for starting a washing machine electric motor comprises a step of conventional starting of the electric motor until its steady state, a step of monitoring the electrical supply voltage of the electric motor (or a step of monitoring at least one magnitude intrinsic to the electric motor operation), a step of comparing the actual value of the electrical supply voltage of the electric motor with a predetermined reference value (or a step of comparing also the actual value of the magnitude intrinsic to the electric motor operation with a predetermined reference value), and a maintenance phase of starting of the electric motor, after the consolidation of its steady state by controlling the firing angle of the electrical supply voltage of the electric motor.

The great inventive aspect of the invention lies in the fact that that the firing angle control of the electrical supply voltage of the electric motor, instead of being fixed as described in the document PI 0402937-2, comprises a dynamic control based on the result of the comparisons between the actual value or the electrical supply voltage of the electric motor with at least one predetermined reference value, or between the actual value of the magnitude intrinsic to the electric motor operation with at least one predetermined reference value.

The logic of this dynamic modification is based on the generation of an error signal between the actual value of the electrical supply voltage and a reference value. More particularly, the error signal is numerically equal to the difference between the actual value of the electrical supply voltage and a reference value, which is arbitrary and/or experimentally obtained.

Preferably, the reference value refers to the value of rated voltage for which the motor was designed to; therefore, the reference value can be suitable for different washing machines platforms.

Depending on the error signal (difference between the actual value of the electrical supply voltage and a reference value), is expected to generate an additional correction signal ASC that will directly act in the firing of TRIACs.

The main objective is that the additional correction signal ASC, which varies depending on the amplitude of the error signal, be able to “fire” the TRIACs so that they are able, through its characteristic function, of maintaining essentially constant the current and/or voltage and/or torque of the washing machine electric motor.

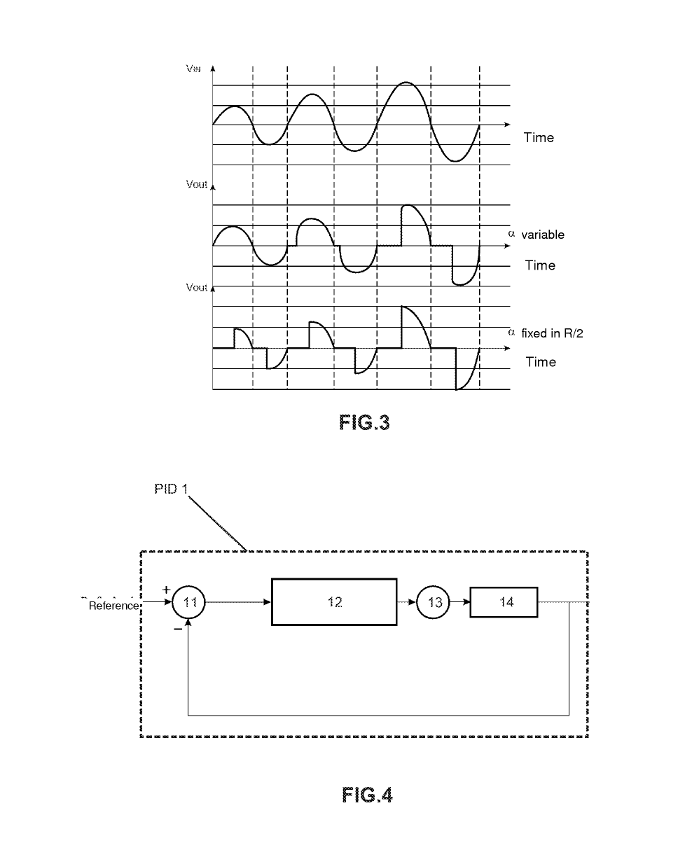

FIG. 3 illustrates a graph of starting a washing machine electric motor according to the present invention.

Said additional correction signal ASC can be electrically generated in many different ways (already known by those skilled in the art). Preferably, the said additional correction signal is generated by a PID 1 controller, as illustrated in FIG. 4.

Still preferably, the mentioned PID 1 controller can be implemented in a digital microcontroller existing on the washing machine (in the conventional control circuit of the washing machine electric motor).

In this embodiment, said PID 1 controller is mainly comprised of error signal calculation module 11 (difference between the actual value of the electrical supply voltage and a reference value) for a PID-type calculation module 12 (proportional, integrative and derivative), for the additional correction signal ACS calculation module 13, and a “power” signal output module 14 to be sent to the TRIACs triggers.

The PID controller 1 according to the present invention, has its functional mathematical principle based on the following equation:

$${I}_{Tef} = \frac{{I}_{m}}{\sqrt{2} π} \times {\{ \begin{matrix}\begin{matrix}\frac{β - α}{2} + \frac{sen 2 ( α - β ) - sen 2 ( β - α )}{4} + \frac{2 sen ( α - ∅ )}{( cot {g}^{2} ∅ + 1 )} \times \\ [ \begin{matrix}{e}^{co t g ∅ ( α - β )} \times ( cot g ∅ \times sen β + cos β ) - \\ ( cot g ∅ \times sen α + cos α )\end{matrix} ] -\end{matrix} \\ \frac{2 sen ( α - ∅ ) \times sen ∅}{( cot {g}^{2} ∅ + 1 )} \times [ \begin{matrix}{e}^{co tg ∅ ( α - β )} \times \\ ( cot g ∅ \times cos β - sen β ) - \\ ( cot g ∅ \times cos α - sen α )\end{matrix} ] + \\ \frac{{sen}^{2} ( α - ∅ )}{2 cot g ∅} \times [ 1 - {e}^{2 co t g ( α - β )} ]\end{matrix} \}}^{\frac{1}{2}}$$

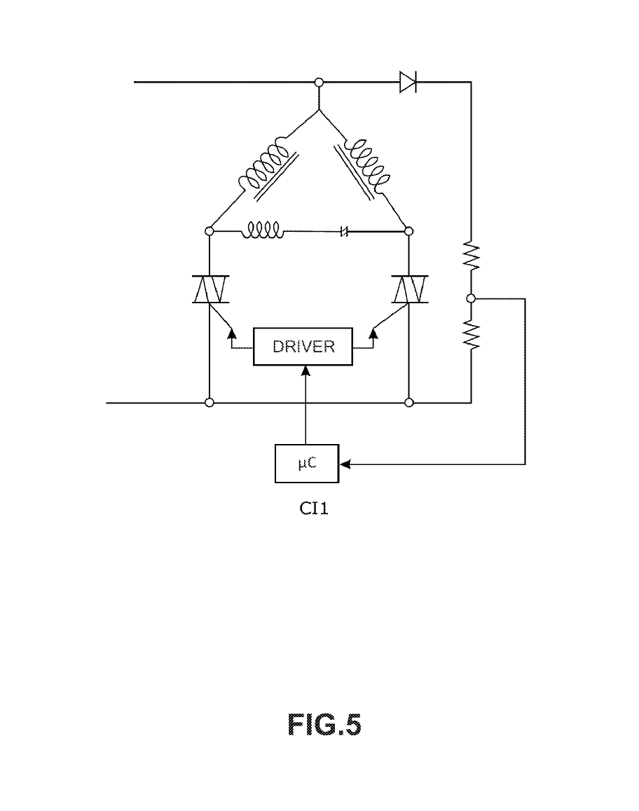

FIG. 5 then illustrates the combination of a current control system of washing machine motor with PID 1 controller, which is able to emulate the method for starting a washing machine electric motor herein revealed.

The system according to FIG. 5, consists of a power driver, microcontroller, feedback and load to be driven (motor, start capacitor and inductor protection). The driver has the function of providing the necessary current to start conducting the current in the thyristor so that it can conduct full half cycle independently, even in the absence of current in the gate. The microcontroller is the brain of the system, calculating the exact time to trigger the TRIAC according to zerocross synchronization with the electric power voltage. The feedback circuit, at the same time, provides a reference to the “zerocross” to feed the micro with the peak electrical grid which is used to scale the adjustment of the firing angle for correcting magnetization loss/motor torque in cases of low voltage.

Every invention was, in fact, designed so as to measure and compare the electrical supply voltage (electric power voltage) and the ideal voltage (rated motor voltage) in order to generate a correction signal that, once it is sent to TRIACs, is able to maintain a constant voltage to the electric motor next to the ideal voltage, regardless of variations and oscillations of electric power voltage.

It means that it is necessary to use at least one dedicated sensor to measure said electrical supply voltage (electric power voltage).

However, in silico tests showed that the variations and oscillations of electrical supply voltage (without the implementation of the method disclosed herein, it is worth emphasizing) are directly responsible for variations and oscillations of speed and electric motor torque. Moreover, although it was found that these variations and oscillations of speed and electric motor torque are basically proportional to variations and oscillations of electric power voltage.

Consequently, and by deductive logic, also proven in in silico tests, it was found that the method for starting a washing machine electric motor can be fully grounded in the readings and comparisons between speed and/or torque and real speed and/or torque. Make such comparisons, in this case, is the same as comparing the electrical supply voltage with the motor rated voltage.

It means that all the logic described above, where only voltages are compared, it is completely valid and functional for comparisons between real speed and/or torque and speed and/or electric motor torque.

Thus, it creates an alternative option that, besides being implemented in a single PID controller 1, as shown in FIG. 4, shows equivalent results.

Namely, by comparing speed and/or torque and real speed and/or electric motor torque is also possible to generate an error signal, and from the processing of this error signal, it is also possible to generate an additional correction signal ASC.

In general, this option also turns out to respect the functional mathematical principle illustrated above, after all, the signs of speed and/or torque are nothing more than electrical signals (converted from mechanical magnitudes) proportional to the voltage imposed to supply terminals of the electric motor.

Thus, it is important to emphasize that the option of buying real speed and/or torque and speed and/or electric motor torque is not about another invention, but rather, an optional way to accomplish the same invention, nevertheless, when talking about electric motor washing machine, some magnitudes (voltage, torque and speed) are proportional and fully associated to each other.

This is particularly interesting in cases where there is difficulty of measuring (through modular sensors) the electric power voltage, being easier, therefore, to measure the speed and/or electric motor torque itself.

It is also important to note that regardless of the magnitudes to be compared (voltage, motor speed and motor torque) the additional correction signal ASC has the sole purpose of controlling the firing angle of the electrical supply voltage of the electric motor through TRIACs already existing.

1. Method for starting a washing machine electric motor, comprising at least the following steps:
(a) conventional starting of the electric motor until its steady state;
(b) monitoring the electrical supply voltage of the electric motor;
(c) comparing the actual value of the electrical supply voltage of the electric motor, monitored in step (b), with at least one predetermined reference value, and
(d) maintaining the starting of the electric motor, after the consolidation of its steady state, by controlling the firing angle of the electrical supply voltage of the electric motor;
the method of starting a washing machine electric motor being particularly CHARACTERIZED by the fact that said firing angle control of the electrical supply voltage of the electric motor, of step (d), comprises a dynamic control based on the result of the comparisons performed in step (c).

2. Method according to claim 1, CHARACTERIZED by the fact that the predetermined reference value comprises the rated voltage of the electric motor.

3. Method according to claim 1, CHARACTERIZED by the fact that it generates at least one additional correction signal (ASC) based on the result of the comparison between the actual value of the electrical supply voltage of the electric motor and at least one predetermined reference value, at least one additional correction signal (ASC) being responsible for controlling the firing angle of the electrical supply voltage of the electric motor.

4. Method according to claim 3, CHARACTERIZED by the fact that at least one additional correction signal (ASC) is sent via hardware to the thyristor responsible for the power supply of the washing machine electric motor.

5. Method for starting a washing machine electric motor, comprising at least the following steps:
(a) conventional starting of the electric motor until its steady state;
(b) monitoring at least one magnitude intrinsic to the electric motor operation;
(c) comparing the actual value of the magnitude intrinsic to the electric motor operation, monitored in step (b), with at least one predetermined reference value, and
(d) maintaining the starting of the electric motor, after the consolidation of its steady state, by controlling the firing angle of the electrical supply voltage of the electric motor;
the method of starting a washing machine electric motor being particularly CHARACTERIZED by the fact that said firing angle control of the electrical supply voltage of the electric motor, of step (d), comprises a dynamic control based on the result of the comparisons performed in step (c).

6. Method according to claim 5, CHARACTERIZED by the fact that the magnitude intrinsic to the electric motor operation comprises the electric motor torque.

7. Method according to claim 5, CHARACTERIZED by the fact that the predetermined reference value comprises the electric motor torque.

8. Method according to claim 5, CHARACTERIZED by the fact that the magnitude intrinsic to the electric motor operation comprises the electric motor speed.

9. Method according to claim 5, CHARACTERIZED by the fact that the predetermined reference value comprises the electric motor speed.

10. Method according to claim 5, CHARACTERIZED by the fact of generating at least one additional correction signal (ASC) based on the comparison result of the comparison between the actual value of the magnitude intrinsic to the electric motor operation and at least one predetermined reference value, at least one additional correction signal (ASC) being responsible for controlling the firing angle of the electrical supply voltage of the electric motor.

11. Method according to claim 10, CHARACTERIZED by the fact that at least one additional correction signal (ASC) is sent via hardware to the thyristor responsible for the power supply of the washing machine electric motor.
